(19) United States
(12) Patent Application Publication
(10) Pub. No.: US 2011/0074208 A1
(43) Pub. Date: Mar. 31, 2011

(54) PUMP UNIT FOR ELECTRONIC CONTROL BRAKE SYSTEM

(76) Inventor: Min Geun SONG, Dae jeon (KR)

(21) Appl. No.: 12/893,458

(22) Filed: Sep. 29, 2010

(30) Foreign Application Priority Data
Sep. 29, 2009 (KR) 10-2009-0092328
Sep. 29, 2009 (KR) 10-2009-0092329
Sep. 29, 2009 (KR) 10-2009-0092330

(51) Int. Cl. B60T 13/16

(52) U.S. Cl. 303/10

(57) ABSTRACT

Disclosed is a pump unit for an electronic control brake system. The pump unit includes first to third pumps arranged on a first plane at angular positions of 120°, 60°, and 180°, respectively, and fourth to sixth pumps arranged on a second plane spaced apart from the first plane in parallel to the first plane. The fourth to sixth pumps are arranged at angular positions 60°, 120°, and 180°, respectively, so that the hydraulic pressure pulsation is reduced during the pump operation and a brake oil pressure is rapidly formed.

This application claims the benefit of Korean Patent Application Nos. 10-2009-0092328, 10-2009-0092329, and 10-2009-0092330 filed on Sep. 29, 2009, in the Korean Intellectual Property Office, the disclosure of which is incorporated herein by reference.

### BACKGROUND

1. Field

The discloser relates to a pump unit for an electronic control brake system, capable of rapidly forming a brake oil pressure while reducing hydraulic pressure pulsation generated in pump operation by improving the arrangement structure of pumps.

2. Description of the Related Art

In general, electronic control brake systems are used to obtain strong and stable braking force by effectively preventing a vehicle from slipping. The electronic control brake systems have been developed as an ABS (Anti-Lock Brake System) to prevent a wheel from slipping during a braking operation, a BTCS (Brake Traction Control System) to prevent a driving wheel from slipping upon sudden start or sudden acceleration of a vehicle, and a VDC (Vehicle Dynamic Control System) to stably maintain the driving state of the vehicle by controlling a brake oil pressure in the combination of the ABS and the BTCS.

Each of the electronic control brake systems includes a plurality of solenoid valves to control a brake oil pressure transferred to a hydraulic brake mounted on wheels of a vehicle, low and high pressure accumulators to temporarily store oil flowing out of the hydraulic brake, a motor and pumps to forcibly pump the oil of the low pressure accumulators, and an ECU (Electronic Control Unit) to control the driving of the motor and the solenoid valves. These components are compactly embedded in a modulator block made of aluminum.

Therefore, the electronic control brake system performs the electronic control for the wheels by compressing and pumping the oil of the low pressure to the high pressure accumulators through the operation of the pumps, and transferring the oil to the hydraulic brake or a master cylinder assembly.

However, the electronic control brake system according to the related art has a dual pump-type structure in which two pumps are coupled with one motor. In other words, each pump performs one suction stroke and one exhaust stroke as a rotational shaft of the motor rotates one time to supply the compressed oil to each hydraulic circuit. Accordingly, the great hydraulic pressure pulsation occurs at the side of a master cylinder in the exhaust stroke of the pump, and the brake pressure of the hydraulic brake may not be rapidly formed when the pumps operate to control the wheels.

### SUMMARY

Accordingly, it is an aspect of the disclosure to provide a pump unit for an electronic control brake system, capable of rapidly forming a brake oil pressure while reducing hydraulic pressure pulsation generated in pump operation by improving the arrangement structure of pumps.

Additional aspects and/or advantages of the disclosure will be set forth in part in the description which follows and, in part, will be apparent from the description, or may be learned by practice of the disclosure.

The foregoing and/or other aspects of the disclosure are achieved by providing a pump unit for an electronic control brake system having a shaft of a motor part for driving the pump unit, the pump unit including first to sixth pumps installed in first and second hydraulic circuits linking a master cylinder assembly with a plurality of brake cylinders to form a closed circuit. The first to third pumps of the pump unit are arranged on a first plane vertically intersecting a third plane including a rotational axis of the shaft, the first pump is arranged about an axis of the intersection between the first plane and the third plane, the second pump is arranged counterclockwise away from the first pump at an angle of about 120 degrees, and the third pump is arranged clockwise away from the first pump at an angle of about 60 degrees.

According to the disclosure, the fourth to sixth pumps are arranged on a second plane parallel to the first plane in a direction of the rotational axis, the fourth pump is arranged about an axis of intersection between the second and third planes while facing the first pump, the fifth pump is arranged about an axis counterclockwise away from the fourth pump at an angle of about 60 degrees, and the sixth pump is arranged about an axis clockwise away from the fourth pump at an angle of about 120 degrees.

According to the disclosure, the shaft includes a first eccentric part corresponding to the first plane and a second eccentric part corresponding to the second plane.

According to the disclosure, the first and second eccentric parts have an eccentric phase difference of about 180 degrees.

According to the disclosure, the first, second, and fifth pumps are connected to the first hydraulic circuit, and remaining three pumps are connected to the second hydraulic circuit.

According to another embodiment of the disclosure, there is provided a pump unit for an electronic control brake system having a shaft of a motor part for driving the pump unit. The pump unit includes first to sixth pumps installed in first and second hydraulic circuits linking a master cylinder assembly with a plurality of brake cylinders to form a closed circuit. The first to third pumps of the pump unit are arranged on a first plane vertically intersecting a third plane including a rotational axis of the shaft, the first pump is arranged about an axis of the intersection between the first plane and the third plane, the second pump is arranged counterclockwise away from the first pump at an angle of about 60 degrees, and the third pump is arranged counterclockwise away from the first pump at an angle of about 120 degrees. The fourth to sixth pumps are arranged on a second plane parallel to the first plane in a direction of the rotational axis, the fourth pump is arranged about an axis of intersection between the second and third planes while facing the first pump, the fifth pump is arranged about an axis clockwise away from the fourth pump at an angle of about 60 degrees, and the sixth pump is arranged about an axis counterclockwise away from the fourth pump at an angle of about 120 degrees.

According to the disclosure, the shaft includes a first eccentric part corresponding to the first plane and a second eccentric part corresponding to the second plane.

According to the disclosure, the first and second eccentric parts have an eccentric phase difference of about 60 degrees.

According to the disclosure, the first, third, and sixth pumps are connected to the first hydraulic circuit, and remaining three pumps are connected to the second hydraulic circuit.

According to still another embodiment of the present invention, there is provided a pump unit for an electronic control brake system having a shaft of a motor part for driving the pump unit. The pump unit includes first to sixth pumps installed in first and second hydraulic circuits linking a master cylinder assembly with a plurality of brake cylinders to form a closed circuit. The first to third pumps of the pump unit are arranged on a first plane vertically intersecting a third plane including a rotational axis of the shaft, the first pump is arranged clockwise away from the third plane at an angle of about 30 degrees, the second pump is arranged counterclockwise away from the first pump at an angle of about 120 degrees, and the third pump is arranged counterclockwise away from the first pump at an angle of about 90 degrees. The fourth to sixth pumps are arranged on a second plane parallel to the first plane in a direction of the rotational axis, the fourth pump is arranged counterclockwise away from the third plane at an angle of about 30 degrees, the fifth pump is arranged about an axis counterclockwise away from the fourth pump at an angle of about 90 degrees, and the sixth pump is arranged about an axis clockwise away from the fourth pump at an angle of about 120 degrees.

According to the disclosure, the shaft includes a first eccentric part corresponding to the first plane and a second eccentric part corresponding to the second plane.

According to the disclosure, the first and second eccentric parts have an eccentric phase difference of about 90 degrees.

According to the disclosure, the first pump, the second pump, and the fifth pump are connected to the first hydraulic circuit, and remaining three pumps are connected to the second hydraulic circuit.

As described above, in the electronic control brake system according to one embodiment of the disclosure, rapid response performance can be ensured upon the operation of a motor and a pump. In addition, durability of the electronic control brake system can be improved and the hydraulic pressure pulsation can be reduced by reducing the load and the number of operations of the elements so that a user can comfortably steps on a brake pedal and the operating noise of the system can be reduced.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a hydraulic system diagram of an electronic control brake system according to one embodiment of the disclosure;

FIG. 2 is a perspective view schematically showing the arrangement structure of a motor and a pump unit according to one embodiment of the disclosure;

FIG. 3 is a view showing a pump unit arranged on a first plane according to one embodiment of the disclosure;

FIG. 4 is a view showing a pump unit arranged on a second plane according to one embodiment of the disclosure;

FIG. 5 is a perspective view schematically showing the connection structure of a pump unit and a hydraulic circuit according to one embodiment of the disclosure;

FIG. 6 is a hydraulic system diagram of an electronic control brake system according to another embodiment of the disclosure;

FIG. 7 is a perspective view schematically showing the arrangement structure of a motor and a pump unit according to another embodiment of the disclosure;

FIG. 8 is a view showing a pump unit arranged on a first plane according to another embodiment of the disclosure;

FIG. 9 is a view showing a pump unit arranged on a second plane according to another embodiment of the disclosure;

FIG. 10 is a perspective view schematically showing the connection structure of a pump unit and a hydraulic circuit according to another embodiment of the disclosure;

FIG. 11 is a hydraulic system diagram of an electronic control brake system according to still another embodiment of the disclosure;

FIG. 12 is a perspective view schematically showing the arrangement structure of a motor and a pump unit according to still another embodiment of the disclosure;

FIG. 13 is a view showing a pump unit arranged on a first plane according to still another embodiment of the disclosure;

FIG. 14 is a view showing a pump unit arranged on a second plane according to still another embodiment of the disclosure; and

FIG. 15 is a perspective view schematically showing the connection structure of a pump unit and a hydraulic circuit according to still another embodiment of the disclosure.

### DETAILED DESCRIPTION OF THE EXEMPLARY EMBODIMENTS

Reference will now be made in detail to the embodiments of the disclosure, examples of which are illustrated in the accompanying drawings, wherein like reference numerals refer to the like elements. The embodiments are described below to explain the disclosure by referring to the figures.

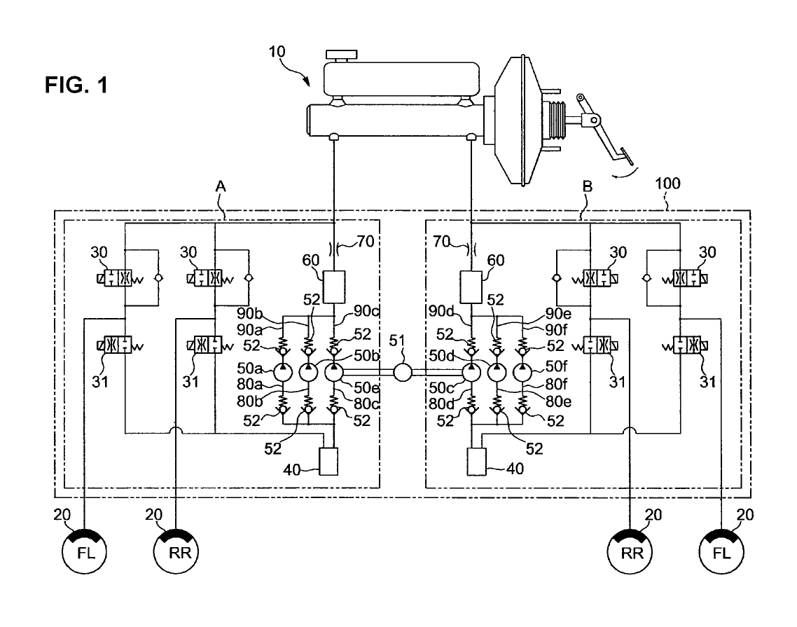

FIG. 1 is a hydraulic system diagram of an electronic control brake system according to one embodiment of the disclosure.

As shown in FIG. 1, an electronic control brake system according to one embodiment of the disclosure includes a master cylinder assembly 10 to provide braking force, a plurality of brake cylinders 20 to achieve a braking operation, and first and second hydraulic circuits A and B connecting the master cylinder assembly 10 and the brake cylinders 20 to form a closed circuit. In this case, since the first and second hydraulic circuits A and B have the same arrangement structure, only the first hydraulic circuit A will be representatively described below except for a specific case related to the structure of the second hydraulic circuit B.

The first and second hydraulic circuits A and B include a plurality of solenoid valves 30 and 31 to intermittently control the transmission of a braking oil pressure formed in the master cylinder assembly 10 to each brake cylinder 20, and low pressure accumulators 40 to temporarily store oil returning from the brake cylinders 20.

In addition, the electronic control brake system according to the disclosure further includes a pump unit 50 to re-circulate oil stored in the low accumulator 40 by compressing the oil, a motor part 51 to drive the pump unit 50, and a high pressure accumulator 60 to damp hydraulic pressure pulsation of oil discharged from the pump unit 50.

The pump unit 50 includes a first pump 50a, a second pump 50b, a third pump 50c, a fourth pump 50d, a fifth pump 50e, and a sixth pump 50f. Among them, the first pump 50a, the second pump 50b, and the fifth pump 50e are connected to the first hydraulic circuit A, and the third pump 50c, the fourth pump 50c, and the sixth pump 50f are connected to the second hydraulic circuit B. A check valve 52 is provided at suction and exhaust sides of the first to sixth pumps 50a to 50f to prevent the oil from flowing back.

The above devices are compactly embedded in a modulator block 100 having a rectangular parallelepiped shape and made of aluminum Al. The modulator block 100 is provided therein with a plurality of fluid passages connecting the devices to each other.

The solenoid valves 30 and 31 are classified into a normal-open solenoid valve 30 (hereinafter, referred to as “NO-type solenoid valve”) provided at an upstream fluid passage of the brake cylinder 20 to maintain an open state in a normal time, and a normal-close solenoid valve 31 (hereinafter, “NC-type solenoid valve”) provided at a downstream fluid passage of the brake cylinder 20 to maintain a close state in a normal time.

The low pressure accumulator 40 is provided at a passage linking the downstream side of the NC-type solenoid valve 31 to the pump unit 50 to temporarily store oil returning from the brake cylinder 20 due to the opening of the NC-type solenoid valve 31 in the pressure reducing brake operation of the brake cylinder 20. The high pressure accumulator 60 serves as a damping chamber provided at the passage linking the outlet side of the pump unit 50 to the upstream side of the NO-type solenoid valve 30 to damp the hydraulic pressure pulsation of oil discharged from the pump unit 50. Reference number 70 represents an orifice allowing a fluid to stably flow.

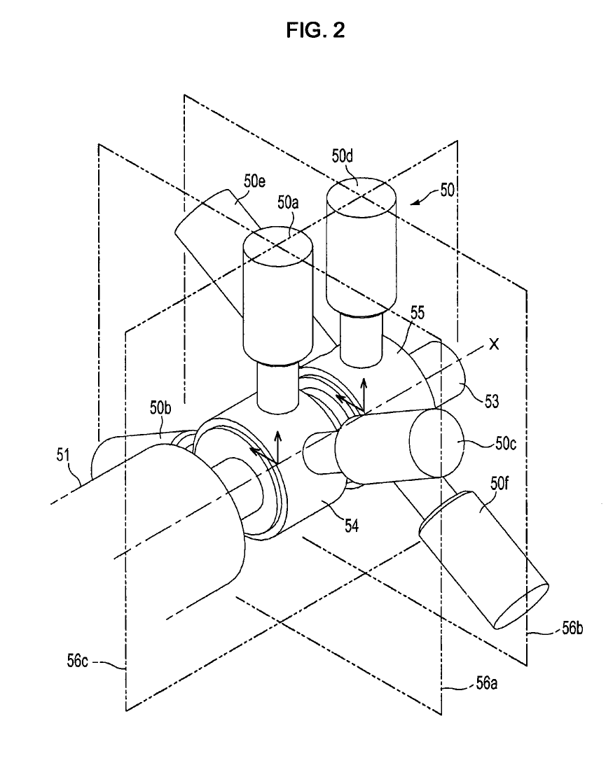

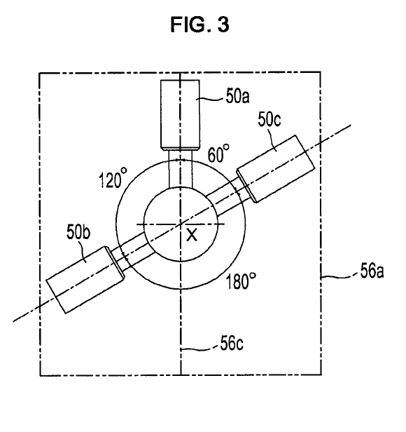

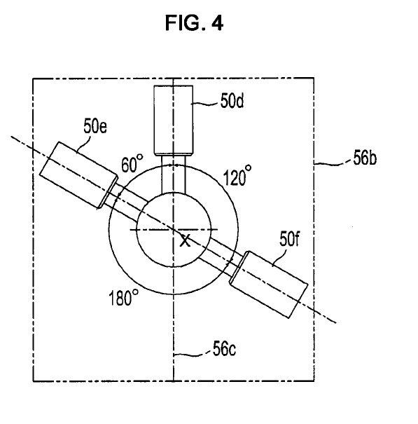

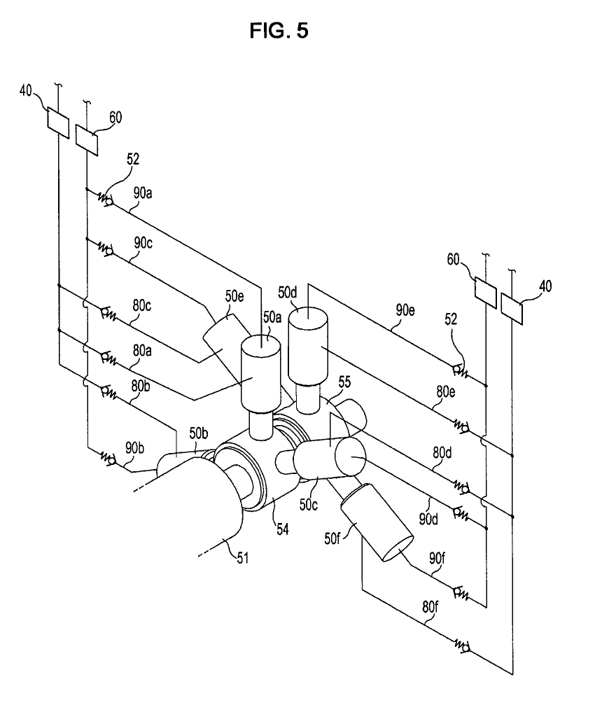

FIG. 2 is a schematic perspective view showing the arrangement structure of a motor and the pump unit 50 according to one embodiment of the disclosure. FIG. 3 is a view showing the pump unit 50 arranged on a first plane according to one embodiment of the disclosure. FIG. 4 is a view showing the pump unit 50 arranged on a second plane according to one embodiment of the disclosure. FIG. 5 is a perspective view showing the connection structure of the pump unit 50 and the hydraulic circuits A and B according to one embodiment of the disclosure.

As shown in FIG. 2, the motor part 51 driving the pump unit 50 includes one motor including a shaft 53 rotating about a rotational axis X. Two eccentric parts 54 and 55 are provided at different positions of the shaft 53 in the direction of the rotational axis X.

The eccentric parts 54 and 55 may be integrated with the shaft 53 or coupled with an eccentric bearing. The eccentric parts 54 and 55 include the first eccentric part 54 adjacent to the motor part 51 and the second eccentric part 55 spaced apart from the first eccentric part 54 at a predetermined interval.

The first and second eccentric parts 54 and 55 are provided corresponding to a piston (not shown) of the pump unit 50 to be described below such that the first and second eccentric parts 54 and 55 are connected to the piston. The first and second eccentric parts 54 and 55 have a predetermined eccentric phase difference therebetween.

According to the present embodiment, the first and second eccentric parts 54 and 55 may have an eccentric phase difference of about 180 degrees.

Accordingly, the pump unit 50 including six pumps to be described below sequentially receives loads. Therefore, the shaft 53 of the motor part 51 is not excessively loaded, so that the durability of the pump unit 50 can be improved.

Hereinafter, the arrangement structure of the pump unit 50 operated by the eccentric parts 54 and 55 provided on the shaft 53 of the motor part 51 will be described.

The shaft 53 is provided thereon with a third plane 56c including the rotational axis X, and first and second planes 56a and 56b which vertically intersect the third plane 56c and are provided at different positions in the direction of the rotational axis X while being parallel to each other.

The first plane 56a is positioned corresponding to the first eccentric part 54 provided on the shaft 53, and the second plane 56b is positioned corresponding to the second eccentric part 55 provided on the shaft 53.

The first to third pumps 50a, 50b, and 50c are provided on the first plane 56a.

The first pump 50a is arranged about an axis of the intersection between the first and third planes 56a and 56c. As shown in FIG. 3, the second pump 50b is arranged about an axis counterclockwise away from the axis of the first pump 50a at an angle of about 120 degrees on the basis of the rotational axis X, and the third pump 50c is arranged about an axis clockwise away from the axis of the first pump 50a at an angle of about 60 degrees on the basis of the rotational axis X.

In other words, the first pump 50a is arranged away from the second pump 50b at an angle of about 120 degrees, and away from the third pump 50c at an angle of about 60 degrees. The second pump 50b is arranged away from the second pump 50b at an angle of about 180 degrees.

The fourth pump 50d, the fifth pump 50e, and the sixth pump 50f are arranged on the second plane 56b.

The fourth pump 50d is arranged about an axis of the intersection between the second plane 56b and the third plane 56c while facing the first pump 50a. As shown in FIG. 4, the fifth pump 50e is arranged about an axis counterclockwise away from the axis of the fourth pump 50d at an angle of about 60 degrees on the basis of the rotational axis X, and the sixth pump 50f is arranged about an axis clockwise away from the axis of the fourth pump 50d at an angle of about 120 degrees on the basis of the rotational axis X.

In other words, the fourth pump 50d is arranged away from the fifth pump 50e at an angle of about 60 degrees, and away from the sixth pump 50f at an angle of about 120 degrees. The fifth pump 50e is arranged away from the fifth pump 50f at an angle of about 180 degrees.

In the above structure, since the pumps of the pump unit 50 are bilaterally symmetrical to each other about the third plane 56c including the rotational axis X, the arrangement of pistons of the pump unit 50 may be concentrated at one side of the hydraulic circuits A and B.

In other words, as shown in FIG. 1, the first and second pumps 50a and 50b arranged on the first plane 56a and the fifth pump 50e arranged on the second plane 56b may be connected to the first hydraulic circuit A, and the third pump 50c arranged on the first plane 56a and the fourth and sixth pumps 50d and 50f arranged on the second plane 56b may be connected to the second hydraulic circuit B.

Accordingly, in the electronic control brake system according to the embodiment of the disclosure, as the rotational axis X rotates one time, pressures are formed three times in each of the first and second hydraulic circuits A and B, so that the period of a pressure pulse is shorted, and the width of the pressure pulse is narrowed. Accordingly, the vibration and the operating noise of the electronic control brake system are reduced.

Further, in the electronic control brake system according to the disclosure, suction and exhaust passages of the pump unit 50 are directed toward the same surface, so that the spatial arrangement of the pumps and a compact passage design are achieved.

In other words, suction passages 80a, 80b, 80c, 80d, 80e, and 80f and exhaust passages 90a, 90b, 90c, 90d, 90e, and 90f are provided in one direction, so that the share of the low and high pressure accumulators 40 and 60 is easily achieved. In other words, as shown in FIG. 5, the three pumps 50a, 50b, and 50e connected to the first hydraulic circuit A is connected to one low pressure accumulator 40 at the suction side, and connected to one high pressure accumulator 60 at the exhaust side. The three pumps 50c, 50d, and 50f connected to the second hydraulic circuit B are connected one low pressure accumulator 40 at the suction side, and connected to the high pressure accumulator 60 at the exhaust side. Accordingly, the compact brake system is easily designed.

For the purpose of explanation, the first pump 50a, the second pump 50b, and the fifth pumps 50e are connected to the first hydraulic circuit A, and the third pump 50c, the fourth pump 50d, and the sixth pump 50f are connected to the second hydraulic circuit B according to the present embodiment. However, the three pumps connected to the first hydraulic circuit A and the second hydraulic circuit B may vary according to the structure of the hydraulic circuits A and B.

In addition, the above hydraulic circuits according to the disclosure are provided for the purpose of explanation, and the pump units according to the disclosure may be applicable to different hydraulic circuits.

The arrangement structure of the pump unit according to another embodiment of the disclosure will be described below. Hereinafter, the same reference numbers will be designated to the same components, and details thereof will be omitted in order to avoid redundancy.

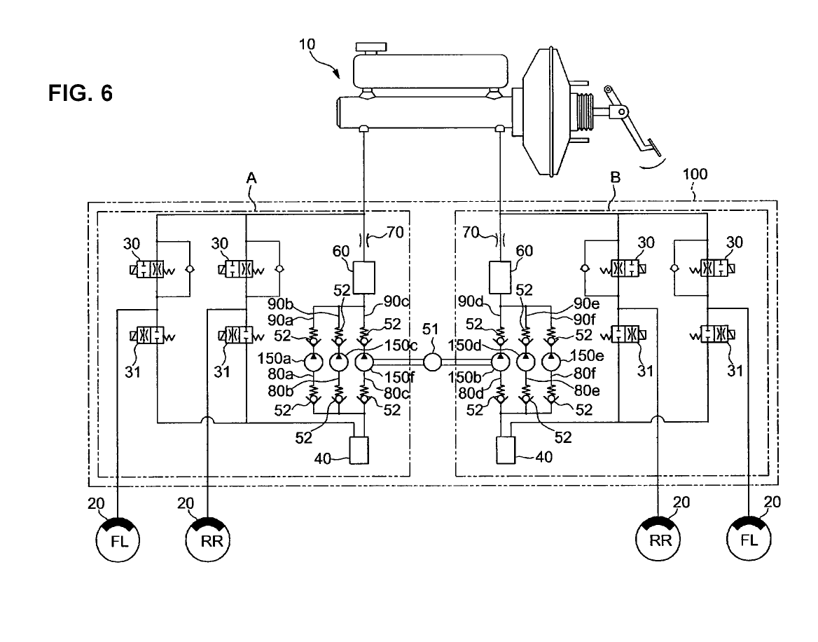

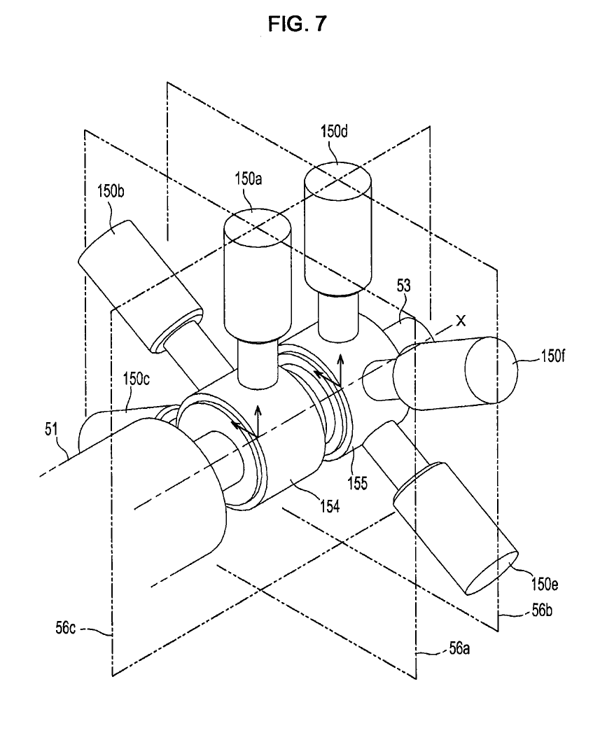

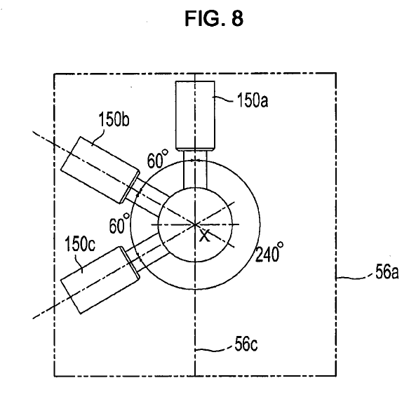

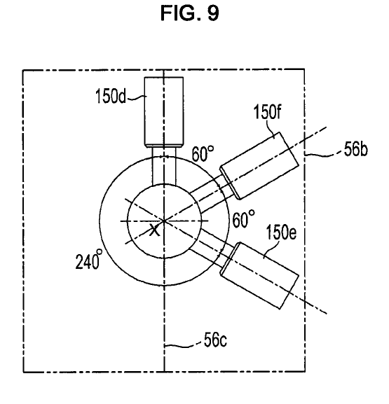

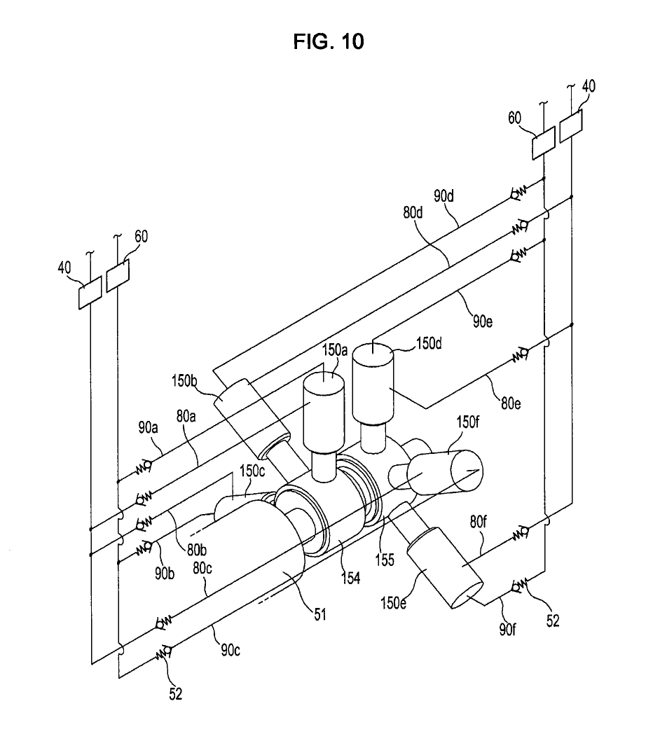

FIG. 6 is a hydraulic system diagram of an electronic control brake system according to another embodiment of the disclosure, and FIG. 7 is a perspective view schematically showing the arrangement structure of the motor and the pump unit according to another embodiment of the disclosure. FIG. 8 is a view showing the pump unit arranged on the first plane according to another embodiment of the disclosure, and FIG. 9 is a view showing the pump unit arranged on the second plane according to another embodiment of the disclosure. FIG. 10 is a perspective view showing the connection structure of the pump unit and the hydraulic circuit according to another embodiment of the disclosure.

Referring to FIGS. 6 and 10, according to the present embodiment, first and second eccentric parts 154 and 155 may have an eccentric phase difference of about 60 degrees.

In addition, first to third pumps 150a, 150b, and 150c are arranged on the first plane 56a.

The first pump 150a is arranged about an axis of the intersection between the first plane 56a and the third plane 56c. As shown in FIG. 8, the second pump 150b is arranged about an axis counterclockwise away from the axis of the first pump 150a at an angle of about 60 degrees on the basis of the rotational axis X. The third pump 150c is arranged about an axis counterclockwise away from the axis of the first pump 150a at an angle of about 120 degrees on the basis of the rotational axis X.

A fourth pump 150d, a fifth pump 150e, and a sixth pump 150f are arranged on the second plane 56b.

The fourth pump 150d is arranged about an axis of the intersection between the second plane 56b and the third plane 56c. As shown in FIG. 9, the fifth pump 150e is arranged about an axis clockwise away from the axis of the fourth pump 150d at an angle of about 120 degrees on the basis of the rotational axis X. The sixth pump 150f is arranged about an axis clockwise away from the axis of the fourth pump 150d at an angle of about 60 degrees on the basis of the rotational axis X.

In other words, the fourth pump 150d is arranged away from the fifth pump 150e at an angle of about 240 degrees, and away from the sixth pump 150f at an angle of about 60 degrees. The fifth pump 150e is arranged away from the fifth pump 150f at an angle of about 60 degrees.

In the above structure, since the pumps of the pump unit 50 are bilaterally symmetrical to each other about the third plane 56c including the rotational axis X, arrangement of pistons of the pump unit 50 may be concentrated at one side of the hydraulic circuits A and B.

According to the present embodiment, as shown in FIG. 6, the first and third pumps 150a and 150c arranged on the first plane 56a and the sixth pump 150f arranged on the second plane 56b may be connected to the first hydraulic circuit A, and the second pump 150b arranged on the first plane 56a and the fourth and fifth pumps 150d and 150e arranged on the second plane 56b may be connected to the second hydraulic circuit B.

Accordingly, in the electronic control brake system according to the embodiment of the disclosure, as the rotational axis X rotates one time, pressures are formed three times in each of the first and second hydraulic circuits A and B, so that the period of a pressure pulse is shorted, and the width of the pressure pulse is narrowed. Accordingly, the vibration and the operating noise of the electronic control brake system are reduced.

Further, in the electronic control brake system according to the disclosure, suction and exhaust passages of the pump unit 51 are directed toward the same surface, so that the spatial arrangement of the pumps and a compact passage design are achieved.

In other words, the suction passages 80a, 80b, 80c, 80d, 80e, and 80f and the exhaust passages 90a, 90b, 90c, 90d, 90e, and 90f are provided in one direction, so that the share of the low and high pressure accumulators 40 and 60 is easily achieved. In other words, as shown in FIG. 10, the three pumps 150a, 150c, and 150f connected to the first hydraulic circuit A is connected to one low pressure accumulator 40 at the suction side, and connected to one high pressure accumulator 60 at the exhaust side. The three pumps 150b, 150d, and 150e connected to the second hydraulic circuit B are connected one low pressure accumulator 40 at the suction side, and connected to the high pressure accumulator 60 at the exhaust side. Accordingly, the compact brake system is easily designed.

The arrangement structure of a pump unit according to still another embodiment of the disclosure will be described below. Hereinafter, the same reference numbers will be designated to the same components, and the details thereof will be omitted in order to avoid redundancy.

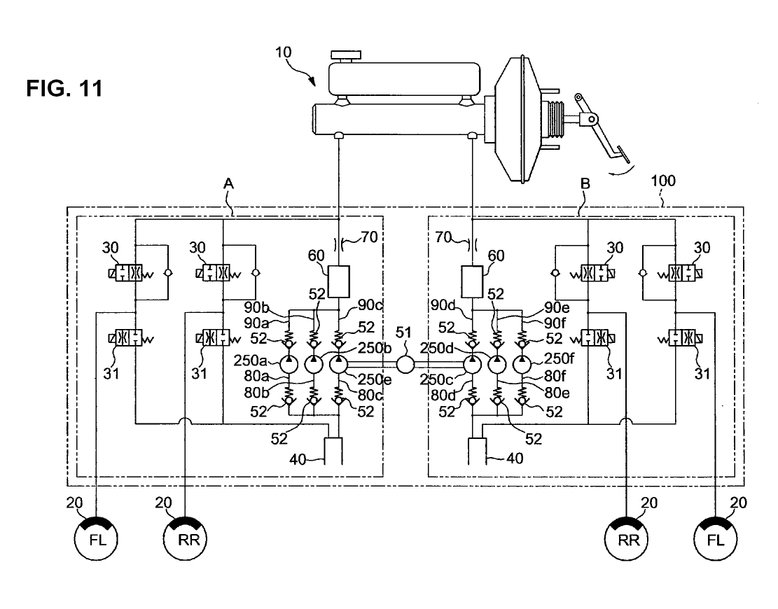

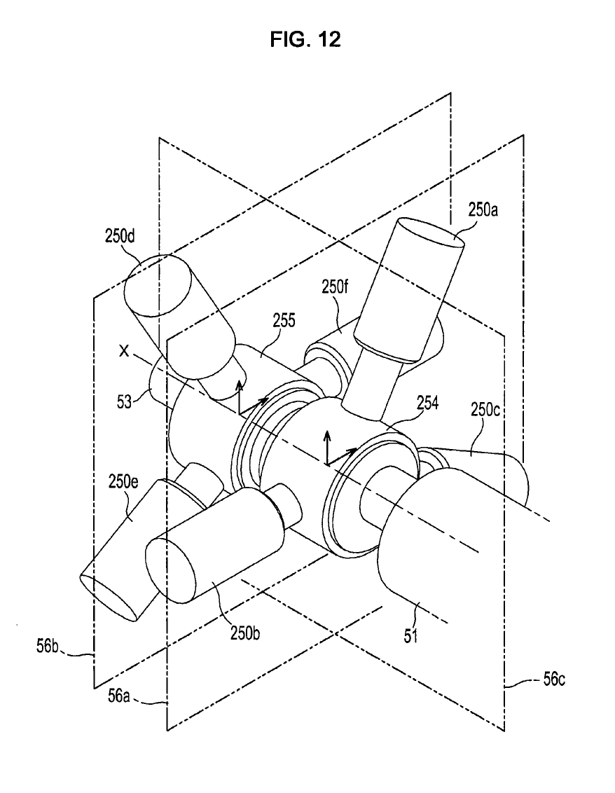

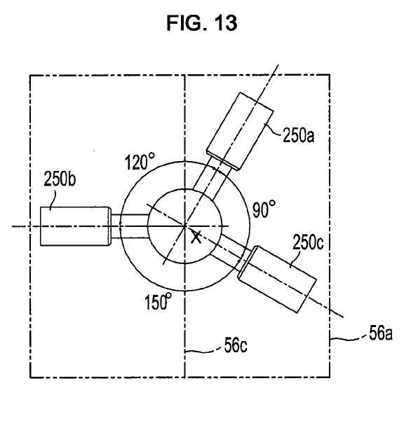

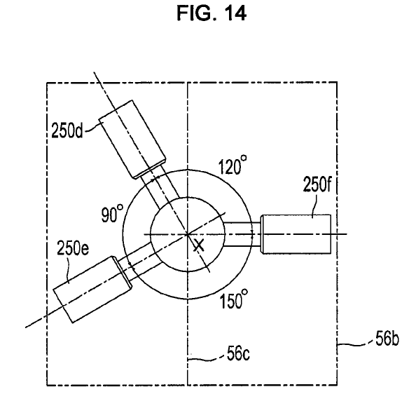

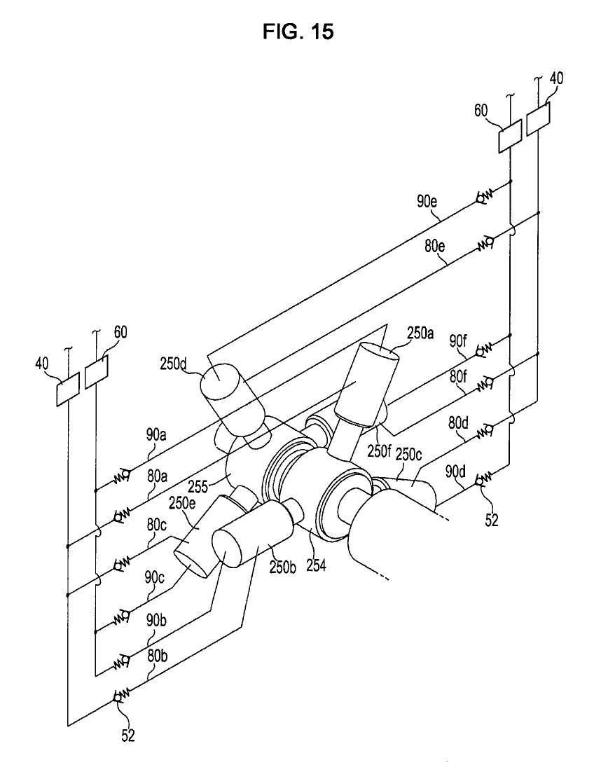

FIG. 11 is a hydraulic system diagram of an electronic control brake system according to still another embodiment of the disclosure, and FIG. 12 is a perspective view schematically showing the arrangement structure of a motor and the pump unit according to still another embodiment of the disclosure. FIG. 13 is a view showing the pump unit arranged on the first plane according to still another embodiment of the disclosure, and FIG. 14 is a view showing the pump unit arranged on the second plane according to still another embodiment of the disclosure. FIG. 15 is a perspective view showing the connection structure of the pump unit and the hydraulic circuit according to still another embodiment of the disclosure.

Referring to FIGS. 11 to 15, first and second eccentric parts 254 and 255 according to the present embodiment have an eccentric phase difference of about 90 degrees.

First, second, and third pumps 250a, 250b, and 250c are arranged on the first plane 56a.

As shown in FIG. 13, the first pump 250a is arranged about an axis clockwise away from the third plane 56c at an angle of about 30 degrees, and the second pump 250b is arranged about an axis counterclockwise away from the axis of the first pump 250a at an angle of about 120 degrees on the basis of the rotational axis X. The third pump 250c is arranged about an axis clockwise away from the axis of the first pump 250a at an angle of about 90 degrees on the basis of the rotational axis X.

In other words, the first pump 250a is arranged away from the second pump 250b at an angle of about 120 degrees, and the second pump 250b is arranged away from the third pump 250c at an angle of bout 150 degrees. The first pump 250a is arranged away from the third pump 250c at an angle of about 90 degrees.

Four, fifth, and sixth pumps 250d, 250e, and 250f are arranged on the second plane 56b.

As shown in FIG. 14, the fourth pump 250d is arranged about an axis counterclockwise away from the third plane 56c at an angle of about 30 degrees, and the fifth pump 250e is arranged about an axis counterclockwise away from the axis of the fourth pump 250d at an angle of about 90 degrees on the basis of the rotational axis X. The sixth pump 250f is arranged about an axis clockwise away from the axis of the fourth pump 250d at an angle of about 120 degrees on the basis of the rotational axis X.

In other words, the fourth pump 250d is arranged away from the fifth pump 250e at an angle of about 90 degrees, and the fifth pump 250e is arranged away from the sixth pump 250f at an angle of bout 150 degrees. The fourth pump 250d is arranged away from the sixth pump 250f at an angle of about 120 degrees.

In the above structure, since the pumps of the pump unit are bilaterally symmetrical to each other about the third plane 56c including the rotational axis X, the arrangement of the pistons of the pump unit may be concentrated at one side of the hydraulic circuits A and B.

According to the present embodiment, as shown in FIG. 15, the first and second pumps 250a and 250b arranged on the first plane 56a and the fifth pump 250e arranged on the second plane 54b may be connected to the first hydraulic circuit A, and the third pump 250c arranged on the first plane 56a and the fourth and sixth pumps 250d and 250f arranged on the second plane 56b may be connected to the second hydraulic circuit B.

Accordingly, in the electronic control brake system according to the embodiment of the disclosure, as the rotational axis X rotates one time, pressures are formed three times in each of the first and second hydraulic circuits A and B, so that the period of a pressure pulse is shorted, and the width of the pressure pulse is narrowed. Accordingly, the vibration and the operating noise of the electronic control brake system are reduced.

Further, in the electronic control brake system according to the disclosure, suction and exhaust passages of the pump unit 50 are directed toward the same surface, so that the spatial arrangement of the pumps and a compact passage design are achieved.

In other words, the suction passages 80a, 80b, 80c, 80d, 80e, and 80f and the exhaust passages 90a, 90b, 90c, 90d, 90e, and 90f are provided in one direction, so that the share of the low and high pressure accumulators 40 and 60 is easily achieved. In other words, as shown in FIG. 15, the three pumps 250a, 250b, and 250e connected to the first hydraulic circuit A is connected to one low pressure accumulator 40 at the suction side, and connected to one high pressure accumulator 60 at the exhaust side. The three pumps 250c, 250d, and 250f connected to the second hydraulic circuit B are connected one low pressure accumulator 40 at the suction side, and connected to the high pressure accumulator 60 at the exhaust side. Accordingly, the compact brake system is easily designed.

Although few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A pump unit for an electronic control brake system having a shaft of a motor part for driving the pump unit, the pump unit comprising:
first to sixth pumps installed in first and second hydraulic circuits linking a master cylinder assembly with a plurality of brake cylinders to form a closed circuit,
wherein the first to third pumps of the pump unit are arranged on a first plane vertically intersecting a third plane including a rotational axis of the shaft, the first pump is arranged about an axis of the intersection between the first plane and the third plane, the second pump is arranged counterclockwise away from the first pump at an angle of about 120 degrees, and the third pump is arranged clockwise away from the first pump at an angle of about 60 degrees, and
wherein the fourth to sixth pumps are arranged on a second plane parallel to the first plane in a direction of the rotational axis, the fourth pump is arranged about an axis of intersection between the second and third planes while facing the first pump, the fifth pump is arranged about an axis counterclockwise away from the fourth pump at an angle of about 60 degrees, and the sixth pump is arranged about an axis clockwise away from the fourth pump at an angle of about 120 degrees.

2. The pump unit of claim 1, wherein the shaft includes a first eccentric part corresponding to the first plane and a second eccentric part corresponding to the second plane.

3. The pump unit of claim 2, wherein the first and second eccentric parts have an eccentric phase difference of about 180 degrees.

4. The pump unit of claim 3, wherein the first pump, the second pump, and the fifth pump are connected to the first hydraulic circuit, and remaining three pumps are connected to the second hydraulic circuit.

5. A pump unit for an electronic control brake system having a shaft of a motor part for driving the pump unit, the pump unit comprising:
first to sixth pumps installed in first and second hydraulic circuits linking a master cylinder assembly with a plurality of brake cylinders to form a closed circuit,
wherein the first to third pumps of the pump unit are arranged on a first plane vertically intersecting a third plane including a rotational axis of the shaft, the first pump is arranged about an axis of the intersection between the first plane and the third plane, the second pump is arranged counterclockwise away from the first pump at an angle of about 60 degrees, and the third pump is arranged counterclockwise away from the first pump at an angle of about 120 degrees, and
wherein the fourth to sixth pumps are arranged on a second plane parallel to the first plane in a direction of the rotational axis, the fourth pump is arranged about an axis of intersection between the second and third planes while facing the first pump, the fifth pump is arranged about an axis clockwise away from the fourth pump at an angle of about 60 degrees, and the sixth pump is arranged about an axis counterclockwise away from the fourth pump at an angle of about 120 degrees.

6. The pump unit of claim 5, wherein the shaft includes a first eccentric part corresponding to the first plane and a second eccentric part corresponding to the second plane.

7. The pump unit of claim 6, wherein the first and second eccentric parts have an eccentric phase difference of about 60 degrees.

8. The pump unit of claim 7, wherein the first pump, the third pump, and the sixth pump are connected to the first hydraulic circuit, and remaining three pumps are connected to the second hydraulic circuit.

9. A pump unit for an electronic control brake system having a shaft of a motor part for driving the pump unit, the pump unit comprising:
first to sixth pumps installed in first and second hydraulic circuits linking a master cylinder assembly with a plurality of brake cylinders to form a closed circuit,
wherein the first to third pumps of the pump unit are arranged on a first plane vertically intersecting a third plane including a rotational axis of the shaft, the first pump is arranged clockwise away from the third Wane at an angle of about 30 degrees, the second pump is arranged counterclockwise away from the first pump at an angle of about 120 degrees, and the third pump is arranged counterclockwise away from the first pump at an angle of about 90 degrees, and
wherein the fourth to sixth pumps are arranged on a second plane parallel to the first plane in a direction of the rotational axis, the fourth pump is arranged counterclockwise away from the third plane at an angle of about 30 degrees, the fifth pump is arranged about an axis counterclockwise away from the fourth pump at an angle of about 90 degrees, and the sixth pump is arranged about an axis clockwise away from the fourth pump at an angle of about 120 degrees.

10. The pump unit of claim 9, wherein the shaft includes a first eccentric part corresponding to the first plane and a second eccentric part corresponding to the second plane.

11. The pump unit of claim 10, wherein the first and second eccentric parts have an eccentric phase difference of about 90 degrees

12. The pump unit of claim 11, wherein the first pump, the second pump, and the fifth pump are connected to the first hydraulic circuit, and remaining three pumps are connected to the second hydraulic circuit.
